(19) United States
(12) Patent Application Publication
(10) Pub. No.: US 2007/0164925 A1
(43) Pub. Date: Jul. 19, 2007

(54) Projection system and control method of the same

(75) Inventor: Yong-chun Song, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/512,203

(22) Filed: Aug. 30, 2006

(30) Foreign Application Priority Data
Oct. 21, 2005 (KR) 10-2005-0099740

(51) Int. Cl. G09G 5/00

(52) U.S. Cl. 345/7

(57) ABSTRACT

A projection system has a display part and a digital light processor (DLP) optical system, the projection system including: a system storage part to store data inherent information corresponding to optical system data of the DLP optical system; a DLP storage part to store the optical system data and the data inherent information corresponding to the optical system data; and a controller to determine whether the data inherent information of the system storage part and the DLP storage part corresponds with each other, after reading out each of the data inherent information from the DLP storage part and the system storage part, in case that the optical system data are downloaded from the DLP storage part to the system storage part, and to download the optical system data if the data inherent information corresponds with each other.

### CROSS-REFERENCE TO RELATED APPLICATIONS

This application claims priority from Korean Patent Application No. 10-2005-0099740, filed on Oct. 21, 2005, in the Korean Intellectual Property Office, the disclosure of which is incorporated herein by reference.

### BACKGROUND OF THE INVENTION

1. Field of the Invention

The present invention relates to a projection system and a control method thereof, and more particularly, to a projection system having a digital micromirror device (DMD) board and a control method thereof.

2. Description of the Related Art

A related art projection system enlarges and projects an image generated by a display device to a screen to provide an enlarged image. The related art projection system has an optical system to embody an image on the screen. Herein, the optical system comprises a light source emitting light, a light system collecting the light from the light source, a display device generating an image with the light from the light system, and a projection-lens system projecting the image generated by the display device to the screen.

The related art projection system has a variety of classifications based on the display devices generating an image. That is, a cathode-ray tube (CRT) device, a liquid crystal display (LCD) device and a liquid crystal on silicon (LCOS) device are mainly used as display devices. A related art DMD having a plurality of minute mirrors is used, which is developed with micro electro mechanical system (MEMS) technology.

A related art digital light processor (DLP) which uses a DMD may have a DMD board to control the DMD and the optical system, in addition to a system board to control the projection system. The DMD board may include a storage part to store data on adjustment of the optical system.

As described above, in case of having an additional DMD board, there is no clear mechanism on data movement between the system board and the DMD board. Thus, while performing data movement, data errors may occur, and the optical system may not be effectively controlled thereby.

### SUMMARY OF THE INVENTION

The present invention provides a projection system and a control method thereof to allow data to be processed efficiently between a system board and a DLP board.

According to an aspect of the present invention, there is provided a projection system having a display part and a DLP optical system, the projection system comprising: a system storage part which stores data inherent information corresponding to optical system data of the DLP optical system; a DLP storage part which stores the optical system data and the data inherent information corresponding to the optical system data; and a controller which determines whether the data inherent information of the system storage part and the DLP storage part correspond with each other, after reading out each of the data inherent information from the DLP storage part and the system storage part, if the optical system data is downloaded from the DLP storage part to the system storage part, and downloads the optical system data if the data inherent information of the system storage part and the DLP storage part corresponds with each other.

According to another aspect of the present invention, the data inherent information comprises an address of the optical system data.

According to another aspect of the present invention, the controller controls display of user information on the display part to inform that a download of the optical system data has been completed.

According to another aspect of the present invention, the controller controls display of user information on the display part to inform that a download of the optical system data has failed if the data inherent information of the system storage part and the DLP storage part does not correspond with each other.

According to another aspect of the present invention, the system storage part further stores the optical system data of the DLP optical system, and the controller determines whether the data inherent information of the system storage part and the DLP storage part corresponds with each other, after reading out each of the data inherent information from the DLP storage part and the system storage part, if the optical system data is downloaded from the system storage part to the DLP storage part, and downloads the optical system data if the data inherent information of the system storage part and the DLP storage part corresponds with each other.

According to another aspect of the present invention, the system storage part stores the optical system data corresponding to a plurality of externally input image sources.

According to another aspect of the present invention, there is provided a control method of a projection system, that comprises a display part, a DLP optical system, a system storage part to store data inherent information corresponding to optical system data of the DLP optical system and a DLP storage part to store the optical system data and data inherent information corresponding to the optical system data, the control method of the projection system comprising: receiving a control signal to download the optical system data from the DLP storage part to the system storage part; reading out each of the data inherent information from the DLP storage part and the system storage part; determining whether the data inherent information of the system storage part and the DLP storage part corresponds with each other; and downloading the optical system data if the data inherent information of the system storage part and the DLP storage part corresponds with each other.

According to another aspect of the present invention, the control method of the projection system further comprises displaying user information on the display part to inform that download of the optical system data is normally completed.

According to another aspect of the present invention, the control method of the projection system further comprises displaying user information on the display part to inform that download of the optical system data has been completed.

According to another aspect of the present invention, there is provided a control method of a projection system, that comprises a display part, a DLP optical system, a system storage part to store optical system data of the DLP optical system and data inherent information corresponding to the optical system data and the DLP storage part to store data inherent information corresponding to the optical system data, the control method of the projection system comprising: receiving a control signal to download the optical system data from the system storage part to the DLP storage part; reading out each of the data inherent information from the DLP storage part and the system storage part; determining whether the data inherent information of the system storage part and the DLP storage part corresponds with each other; and downloading the optical system data if the data inherent information of the system storage part and the DLP storage part corresponds with each other.

According to another aspect of the present invention, the control method of the projection system further comprises displaying user information on the display part to inform that download of the optical system data has been completed.

According to another aspect of the present invention, the control method of the projection system further comprises displaying user information on the display part to inform that a download of the optical system data has failed if the data inherent information of the system storage part and the DLP storage part does not correspond with each other.

According to another aspect of the present invention, the control method of the projection system further comprises determining whether the data inherent information of the system storage part and the DLP storage part corresponds with each other, after reading out each of the data inherent information from the DLP storage part and the system storage part, if the optical system data is downloaded from the DLP storage part to the system storage part, and downloading the optical system data if the data inherent information of the system storage part and the DLP storage part corresponds with each other.

According to another aspect of the present invention, there is provided a computer-readable recording medium storing a computer program for controlling a projection system, that comprises a display part, a DLP optical system, a system storage part to store data inherent information corresponding to optical system data of the DLP optical system and a DLP storage part to store the optical system data and data inherent information corresponding to the optical system data, the method comprising: receiving a control signal to download the optical system data from the DLP storage part to the system storage part; reading out each of the data inherent information from the DLP storage part and the system storage part; determining whether the data inherent information of the system storage part and the DLP storage part corresponds with each other; and downloading the optical system data if the data inherent information of the system storage part and the DLP storage part corresponds with each other.

It is to be understood that both the foregoing general description and the following detailed description are exemplary and explanatory and are intended to provide further explanation of the embodiments as claimed.

### BRIEF DESCRIPTION OF THE DRAWINGS

The above and/or other aspects of the present invention will become apparent and more readily appreciated from the following detailed description of the exemplary embodiments, taken in conjunction with the accompanying drawings of which:

FIG. 1 is a control block diagram of a projection system according to a first exemplary embodiment of the present invention;

FIG. 2 is a control flowchart to explain a control method of the projection system according to the first exemplary embodiment of the present invention;

FIG. 3 is a schematic view of a system storage part and a DLP storage part according to a second exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to like elements throughout.

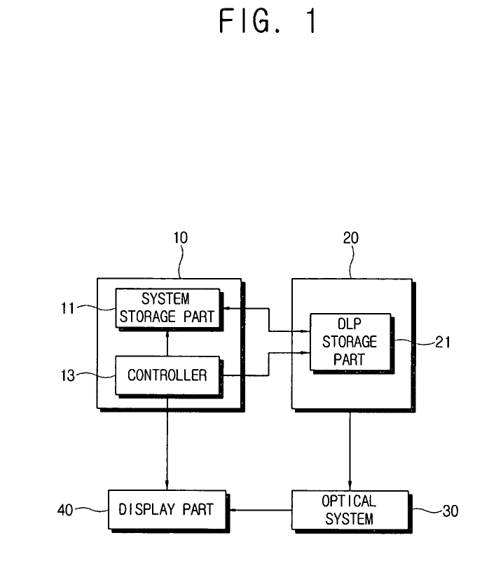

FIG. 1 is a control block diagram of a projection system according to a first exemplary embodiment of the present invention. As shown in FIG. 1, the projection system comprises a system board 10, a DLP board 20, an optical system 30 and a display part 40.

The optical system 30 comprises a light source, a light system, a display device and a projection-lens system (not shown). The light source mainly emits white light. The light system collects the light divided into red, green and blue. The display device is the device such as a DMD, but not limited thereto. Also, the projection-lens system has a plurality of lenses to enlarge and project an image generated by the display device to the display part 40.

The system board 10 comprises a system storage part 11 and a controller 13. The system storage part 11 stores data and on the like to work a projection system. The controller 13 provides overall system control. For example, but not by way of limitation, if the projection system comprises a television, the system board further comprises a tuner to receive an external broadcasting signal.

The DLP board 20 comprises another controller (not shown) to control the optical system 30 and a DLP storage part 21 to store various data in order to control the optical system 30.

The system storage part 11 stores related programs and kinds of data to work the projection system generally, and data inherent information corresponding to optical system data to control the optical system 30. The system storage part 11 may store or may not store the optical system data to control the optical system 30. The DLP board 20 which controls and/or adjusts the DMD and the optical system 30 may be produced and assembled independently from the projection system, such that the optical system data may not be stored in the system storage part 11 at first. However, the optical system data may be stored in the system board 10 according to production processes.

The DLP storage part 21 stores the optical system data to control the optical system 30, particularly, data on the DMD, as the display device. The optical system data comprises information on kinds of equipped lamps, flicker patterns of these lamps, image flips displayed on the display part 40, and color coordinates of the light emitted.

Also, the DLP storage part 21 provides information on the suitability of data movement when the optical system data is moved into the system storage part 11. Herein, the DLP storage part 21 has the data inherent information to detect which positions the optical system data are stored in. Generally, the optical system data is stored in the DLP storage part 21 at first. However, the optical system data can be downloaded from the system storage part 11 in case of DLP board 20 replacement or data errors.

This exemplary embodiment can be applied without regard for any positions of the storage parts 11 and 21 where the optical system data are stored when the optical system data should be moved from one storage part to another storage part.

The data inherent information according to the first exemplary embodiment may be each data storage address. To allow data movement between the system storage part 11 and the DLP storage part 21 to be processed safely and efficiently, the controller 13 may keep track of the storage address of the corresponding data having a function. The data inherent information is not limited to the above mentioned address, and it is possible that any information can be named as data inherent information in case that the controller 13 regards the corresponding information to determine whether there is a problem of data downloading.

The system storage part 11 and the DLP storage part 21 may comprise nonvolatile memory, such as EEPROM (electrically erasable and programmable read only memory), MCU (micro control unit).

The controller 13 reads out the data inherent information stored in both storage parts 11 and 12 to determine whether the data inherent information corresponds with each other after receiving an external control signal of data download. When the data inherent information of both storage parts corresponds with each other, the optical system data are allowed to be downloaded from one storage part to other storage part.

Also, the controller 13 has a function to determine whether the optical system data stored in the DLP storage part 21 is available. If the optical system data is stored in a wrong address or the wrong data is stored in the corresponding address, that is, the optical system data having errors is allowed to be downloaded from the DLP storage part 21 to the system storage part 11, errors may occur in the control of the optical system 30 or the images may not be displayed on the display part 40. Thus, the controller 13 determines whether the optical system data to be downloaded is available after receiving the control signal and allows working on the download.

Also, the controller 13 may determine whether data movement protocol of the optical system data is available for the data movement between both storage parts 11 and 21.

The controller 13 allows the optical system data to be downloaded to a storage part by determining whether the protocol is normal, whether there is data having errors and whether the data inherent information corresponds. Finally, if download is successfully completed, the controller 13 displays the results of each downloading on the display part 40 to inform users that download is normally completed.

However, if there is data having errors, or data inherent information does not correspond with each other, the controller 13 also displays the results on the display part 40 to inform users that the download has failed.

The display part 40 displays an image provided by the optical system 30 and user information on downloading of the optical system data by control of the controller 13.

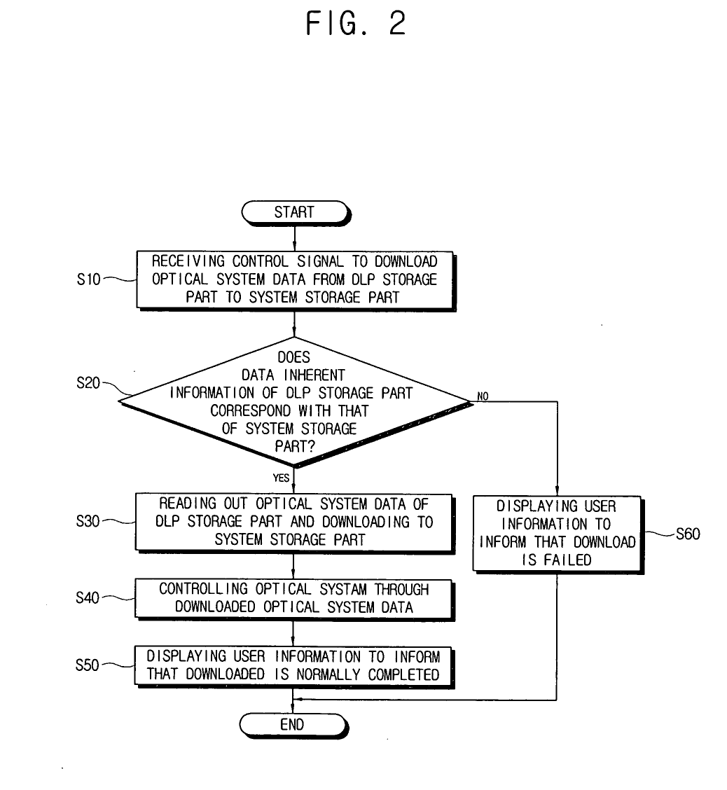

FIG. 2 is a control flowchart to explain an exemplary control method of the projection system according to the first exemplary embodiment. As shown in FIG. 2, the data are downloaded from the DLP storage part 21 to the system storage part 11. However, this control flowchart may also be applied in other conditions.

First, the controller 13 receives a control signal to download the optical system data from the DLP storage part 21 to the system storage part 11 at operation S10.

The controller 13 reads out the data inherent information on the optical data to be downloaded from the DLP storage part 21 and the system storage part 11, and determines whether the data inherent information corresponds with each other at operation S20.

If the data inherent information corresponds with each other, the controller 13 reads the optical system data from the DLP storage data 21 and allows the data to be downloaded to the system storage part 11 at operation S30. To check if download of the optical system data is normally completed, a check-sum operation may be performed after the download operation S30.

The controller 13 controls the optical system 30 through the downloaded optical system data at operation S40 and controls displaying user information on the display part to inform users that download has been completed at operation S50.

However, if the data inherent information does not correspond, the controller 13 displays the user information to inform users that download has failed at operation S60.

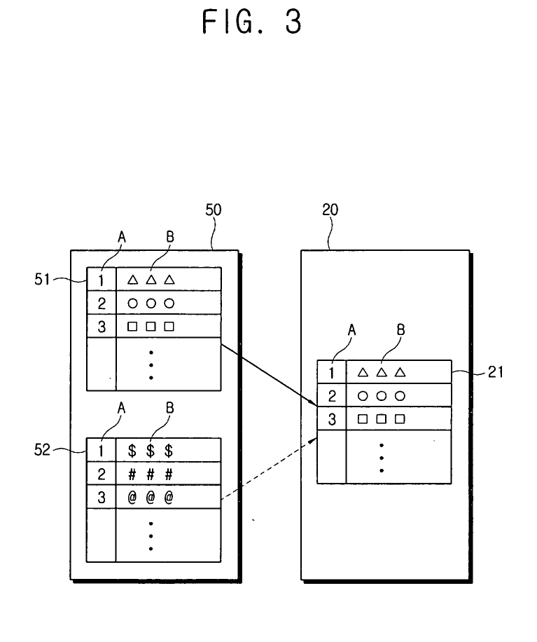

FIG. 3 is a schematic view of a system storage part and a DLP storage part according to a second exemplary embodiment. As shown in FIG. 3, a system board 50 comprises a plurality of the system storage parts 51 and 52. A controller (not shown) according to the second exemplary embodiment is explained with respect to the controller 13 of FIG. 1.

The first and the second system storage parts 51 and 52 store the optical system data corresponding to externally input image sources. A plurality of the image sources comprises TV broadcasting signals input to the projection system, and the image sources input from each of plural input devices such as s-video devices and component devices. The first and the second system storage parts 51 and 52 store these data corresponding to optimum states of optical systems according to each image source. Generally, the capacity of the system storage parts 51 and 52 in the system board 50 is bigger than that of the DLP storage part 21 in the DLP board 20.

When the projection system is produced, the optical system data on a plurality of the image sources may be stored in the first and the second storage parts 51 and 52. The stored optical system data are backed up in the nonvolatile memory of the system board 50 after downloaded from the first and the second storage parts 51 and 52 to the DLP storage part 21. A plurality of the storage parts to store the optical system data may be provided according to the number of the image sources capable of being input to the projector system.

Area B is a storage area of the optical system data, and area A is an address area appointed to the storage information of the optical system data. For example but not by way of limitation, when the optical system data of color-coordinates are downloaded, the controller 13 can determine that the information that the color-coordinate data is stored in the address 1 of a first image source system storage part 51 and in the address 1 of the DLP storage part 21. Thus, the controller 13 allows the color-coordinate data to be downloaded if the addresses correspond with each other after comparing both addresses of the color-coordinates.

Also, when changing the image sources input to the projection system, the controller 13 allows to be downloaded the optical system data stored in the system storage part 52 of the first image source to the DLP storage part 21.

These comparing and determining processes of the controller 13 can solve the problem of the data having errors being transmitted. If the optical system data are added or their addresses are changed, the controller 13 can control the data movement more exactly and safely by using the data inherent information.

The foregoing exemplary embodiments can be realized as computer programs that can be written on a computer-readable recording medium and thus can be executed in a computer. Examples of the computer-readable recording medium include a magnetic storage medium (e.g., a ROM, a floppy disc, or a hard disc), an optical storage medium (e.g., a CD-ROM or a DVD), and a carrier wave (e.g., a data transmission through the Internet).

Although exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A projection system having a display part and a digital light processor (DLP) optical system, the projection system comprising:
a system storage part which stores data inherent information corresponding to optical system data of the DLP optical system;
a DLP storage part which stores the optical system data and the data inherent information corresponding to the optical system data; and
a controller which determines whether the data inherent information of the system storage part and the DLP storage part correspond with each other, after reading out each of the data inherent information from the DLP storage part and the system storage part, if the optical system data is downloaded from the DLP storage part to the system storage part, and downloads the optical system data if the data inherent information of the system storage part and the DLP storage part corresponds with each other.

2. The projection system according to claim 1, wherein the data inherent information comprises an address of the optical system data.

3. The projection system according to claim 1, wherein the controller controls display of user information on the display part to inform that a download of the optical system data has been completed.

4. The projection system according to claim 1, wherein the controller controls display of user information on the display part to inform that a download of the optical system data has failed if the data inherent information of the system storage part and the DLP storage part does not correspond with each other.

5. The projection system according to claim 1, wherein the system storage part further stores the optical system data of the DLP optical system, and
the controller determines whether the data inherent information of the system storage part and the DLP storage part corresponds with each other, after reading out each of the data inherent information from the DLP storage part and the system storage part, if the optical system data is downloaded from the system storage part to the DLP storage part, and downloads the optical system data if the data inherent information of the system storage part and the DLP storage part corresponds with each other.

6. The projection system according to claim 1, wherein the system storage part stores the optical system data corresponding to a plurality of externally input image sources.

7. A control method of a projection system, that comprises a display part, a digital light processor (DLP) optical system, a system storage part to store data inherent information corresponding to optical system data of the DLP optical system and a DLP storage part to store the optical system data and data inherent information corresponding to the optical system data, the control method of the projection system comprising:
receiving a control signal to download the optical system data from the DLP storage part to the system storage part;
reading out each of the data inherent information from the DLP storage part and the system storage part;
determining whether the data inherent information of the system storage part and the DLP storage part corresponds with each other; and
downloading the optical system data if the data inherent information of the system storage part and the DLP storage part corresponds with each other.

8. The control method of the projection system according to claim 7, further comprising displaying user information on the display part to inform that download of the optical system data has been completed.

9. The control method of the projection system according to claim 7, further comprising displaying user information on the display part to inform that download of the optical system data has failed if the data inherent information of the system storage part and the DLP storage part does not correspond with each other.

10. A control method of a projection system, that comprises a display part, a digital light processor (DLP) optical system, a system storage part to store optical system data of the DLP optical system and data inherent information corresponding to the optical system data and the DLP storage part to store data inherent information corresponding to the optical system data, the control method of the projection system comprising:
receiving a control signal to download the optical system data from the system storage part to the DLP storage part;
reading out each of the data inherent information from the DLP storage part and the system storage part;
determining whether the data inherent information of the system storage part and the DLP storage part corresponds with each other; and
downloading the optical system data if the data inherent information of the system storage part and the DLP storage part corresponds with each other.

11. The control method of the projection system according to claim 10, further comprising displaying user information on the display part to inform that download of the optical system data has been completed.

12. The method of claim 10, further comprising displaying user information on the display part to inform that a download of the optical system data has failed if the data inherent information of the system storage part and the DLP storage part does not correspond with each other.

13. The method of claim 10, further comprising:
determining whether the data inherent information of the system storage part and the DLP storage part corresponds with each other, after reading out each of the data inherent information from the DLP storage part and the system storage part, if the optical system data is downloaded from the DLP storage part to the system storage part, and downloading the optical system data if the data inherent information of the system storage part and the DLP storage part corresponds with each other.

14. A computer-readable recording medium storing a computer program for controlling a projection system, that comprises a display part, a digital light processor (DLP) optical system, a system storage part to store data inherent information corresponding to optical system data of the DLP optical system and a DLP storage part to store the optical system data and data inherent information corresponding to the optical system data, the method comprising:
receiving a control signal to download the optical system data from the DLP storage part to the system storage part;
reading out each of the data inherent information from the DLP storage part and the system storage part;
determining whether the data inherent information of the system storage part and the DLP storage part corresponds with each other; and
downloading the optical system data if the data inherent information of the system storage part and the DLP storage part corresponds with each other.

15. The computer readable medium of claim 14, further comprising displaying user information on the display part to inform that download of the optical system data has been completed.

16. The computer readable medium of claim 14, further comprising displaying user information on the display part to inform that download of the optical system data has failed if the data inherent information of the system storage part and the DLP storage part does not correspond with each other.

17. The computer readable medium of claim 14, further comprising:
the system storage part further storing the optical system data of the DLP optical system, and
determining whether the data inherent information of the system storage part and the DLP storage part corresponds with each other, after reading out each of the data inherent information from the DLP storage part and the system storage part, if the optical system data is downloaded from the system storage part to the DLP storage part, and downloading the optical system data if the data inherent information of the system storage part and the DLP storage part corresponds with each other.
